(19) United States
(12) Patent Application Publication
(10) Pub. No.: US 2011/0259626 A1
(43) Pub. Date: Oct. 27, 2011

(54) CABLE WITH TWISTED PAIRS OF INSULATED CONDUCTORS

(75) Inventor: Richard Walter Speer, Kernersville, NC (US)

(73) Assignee: TYCO ELECTRONICS CORPORATION, Berwyn, PA (US)

(21) Appl. No.: 13/174,270

(22) Filed: Jun. 30, 2011

Related U.S. Application Data
(63) Continuation-in-part of application No. 12/688,677, filed on Jan. 15, 2010.

(51) Int. Cl. H01B 11/02

(52) U.S. Cl. 174/113 C

(57) ABSTRACT

A cable includes first and second twisted pairs of insulated conductors, a first inner shield at least partially surrounding the first twisted pair. The first inner shield is at least partially conductive. A second inner shield at least partially surrounds the second twisted pair. The second inner shield is at least partially conductive. An at least partially conductive outer shield at least partially surrounds the first and second twisted pairs and the first and second inner shields such that the first and second twisted pairs and the first and second inner shields extend within an internal passageway of the outer shield.

### CROSS-REFERENCE TO RELATED APPLICATIONS

The present application is a continuation-in-part of and claims priority from U.S. patent application Ser. No. 12/688,677 titled “Cable with Twisted Pairs of Insulated Conductors” filed Jan. 15, 2010, the complete subject matter of which is hereby expressly incorporated by reference in its entirety

### BACKGROUND OF THE INVENTION

The subject matter described and/or illustrated herein relates generally to cables, and more particularly, to cables using at least two twisted pairs of insulated conductors.

Some known data communication cables include pairs of insulated conductors that are twisted together, sometimes referred to as “twisted pairs.” When twisted pairs are closely placed, such as in a cable, electrical energy may be transferred between two or more of the twisted pairs, which is commonly referred to as “crosstalk.” As operating frequencies of data communication cables increase, improved crosstalk isolation between the twisted pairs becomes more important. For example, data communication cables must meet electrical performance characteristics required for transmission at frequencies above a predetermined threshold. Standards organizations, such as the International Electrotechnical Commission (IEC), the International Organization of Standardization (ISO), the Telecommunications Industry Association (TIA) and the Electronics Industry Association (HA), have developed standards which specify specific categories of performance for cable impedance, attenuation, skew, and crosstalk isolation.

Various cable designs have been used to attempt to reduce crosstalk and meet industry standards. For example, some known data communication cables include twisted pairs formed with relatively tight twists. Each twisted pair has a specified distance between twists referred to as the “twist lay.” When adjacent twisted pairs have the same twist lay and/or twist direction, they tend to be more closely spaced, which may increase the amount of crosstalk. Accordingly, each twisted pair within the cable may have a unique twist lay to increase the spacing between pairs and thereby attempt to reduce crosstalk. Moreover, the twist direction of the twisted pairs may also be varied in an attempt to reduce crosstalk. However, varying twist lay and/or direction of the twisted pairs may achieve only limited crosstalk isolation.

Another attempt at solving the problem of twisted pairs lying too closely together within a cable includes a cable having four twisted pairs radially disposed about a central core. Each twisted pair nests between two separators of the central core such that each twisted pair is separated from adjacent twisted pairs by the central core. The central core preserves the geometry of the twisted pairs relative to each other, which may facilitate reducing and/or stabilizing cross talk between the twisted pairs. However, the central core may achieve only a limited reduction of crosstalk.

Accordingly, some of the problems with at least some known data communication cables include an undesirably high amount of crosstalk between twisted pairs. For example, if a cable includes more than four twisted pairs bundled within a common jacket, crosstalk levels may not comply with the transmission requirements of TIA/EIA-568C.

### BRIEF DESCRIPTION OF THE INVENTION

In one embodiment, a cable includes first and second twisted pairs of insulated conductors, a first inner shield at least partially surrounding the first twisted pair. The first inner shield is at least partially conductive. A second inner shield at least partially surrounds the second twisted pair. The second inner shield is at least partially conductive. An at least partially conductive outer shield at least partially surrounds the first and second twisted pairs and the first and second inner shields such that the first and second twisted pairs and the first and second inner shields extend within an internal passageway of the outer shield.

In another embodiment, a cable includes an insulative jacket and sub-cables positioned within the jacket such that the jacket at least partially surrounds the sub-cables. At least some of the sub-cables include first and second twisted pairs of insulated conductors. A first inner shield at least partially surrounds the first twisted pair. The first inner shield is at least partially conductive. A second inner shield at least partially surrounds the second twisted pair. The second inner shield is at least partially conductive. An at least partially conductive outer shield at least partially surrounds the first and second twisted pairs and the first and second inner shields such that the first and second twisted pairs and the first and second inner shields extend within an internal passageway of the outer shield.

### BRIEF DESCRIPTION OF THE DRAWINGS

FIG. 1 is a perspective view illustrating a cross section of a portion of an exemplary embodiment of a cable.

FIG. 2 is a perspective view of a portion of an exemplary embodiment of a central core of a sub-cable of the cable shown in FIG. 1.

FIG. 3 is a cross-sectional view of the central core shown in FIG. 2.

FIG. 4 is a cross-sectional view of an exemplary embodiment of a sub-cable of the cable shown in FIG. 1.

FIG. 5 is a cross-sectional view of the cable shown in FIG. 1.

FIG. 6 is a cross-sectional view of another exemplary embodiment of a cable.

FIG. 7 is a cross-sectional view of a portion of the cable shown in FIG. 6 illustrating an exemplary embodiment of a sub-cable of the cable shown in FIG. 6.

### DETAILED DESCRIPTION OF THE INVENTION

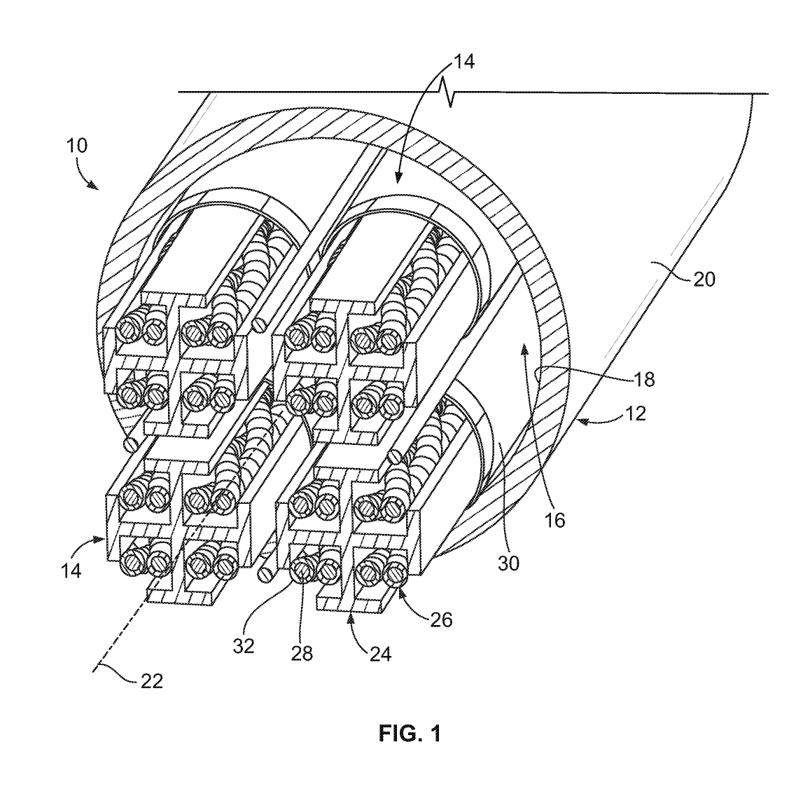

FIG. 1 is a perspective view illustrating a cross section of a portion of an exemplary embodiment of a cable 10. In the description that follows, the cable 10 will be described and/or illustrated in terms of premise cabling, such as, but not limited to, a data communication cable and/or the like. However, it is to be understood that the benefits described and/or illustrated herein are also applicable to other types of cables, including, but not limited to, wires, cords, cables, and/or the like of any type. The following description and illustrations are therefore provided for illustrative purposes only and are but one potential application of the subject matter described and/or illustrated herein.

The cable 10 includes an insulative jacket 12 and a plurality of sub-cables 14 positioned within the jacket 12. A portion of the jacket 12 has been removed from FIG. 1 to illustrate the sub-cables 14. Each sub-cable 14 may be referred to herein as a “cable”. As FIG. 1 illustrates, the jacket 12 at least partially surrounds the sub-cables 14. Specifically, the jacket 12 includes an internal passageway 16 within which the sub-cables 14 extend. The sub-cables 14 extend within the passageway 16 along the length (only a portion of which is illustrated herein) of the cable 10. The jacket 12 is fabricated from any insulative, non-conductive materials, such as, but not limited to, polyvinyl chloride (PVC), polypropylene, a polymer, a fluoropolymer, a plastic, polyethylene, and/or the like. In the exemplary embodiment, the jacket 12 includes an approximately smooth inner surface 18 and an approximately smooth outer surface 20. In alternative embodiments, the inner surface 18 and/or the outer surface 20 may not be approximately smooth. The cable 10 and the jacket 12 extend along a central longitudinal axis 22 that extends along the length of the cable 10.

In the exemplary embodiment, each of the sub-cables 14 includes a central core 24, a plurality of twisted pairs 26 of insulated conductors 28, and a conductive shield 30. The twisted pairs 26 may each be referred to herein as a “first”, a “second”, a “third”, and/or a “fourth” twisted pair. A portion of each of the shields 30 has been removed from FIG. 1 to illustrate the central core 24 and twisted pairs 26. As will be described in more detail below, the central core 24 separates the twisted pairs 26 from one another. As described above, in the exemplary embodiment each of the conductors 28 is at least partially surrounded by an insulative layer 32. The conductors 28 may be fabricated from any conductive materials, such as, but not limited to, copper and/or the like. The insulative layers 32 are fabricated from any insulative, non-conductive materials, such as, but not limited to, PVC, polypropylene, a polymer, a fluoropolymer, a plastic, polyethylene, and/or the like.

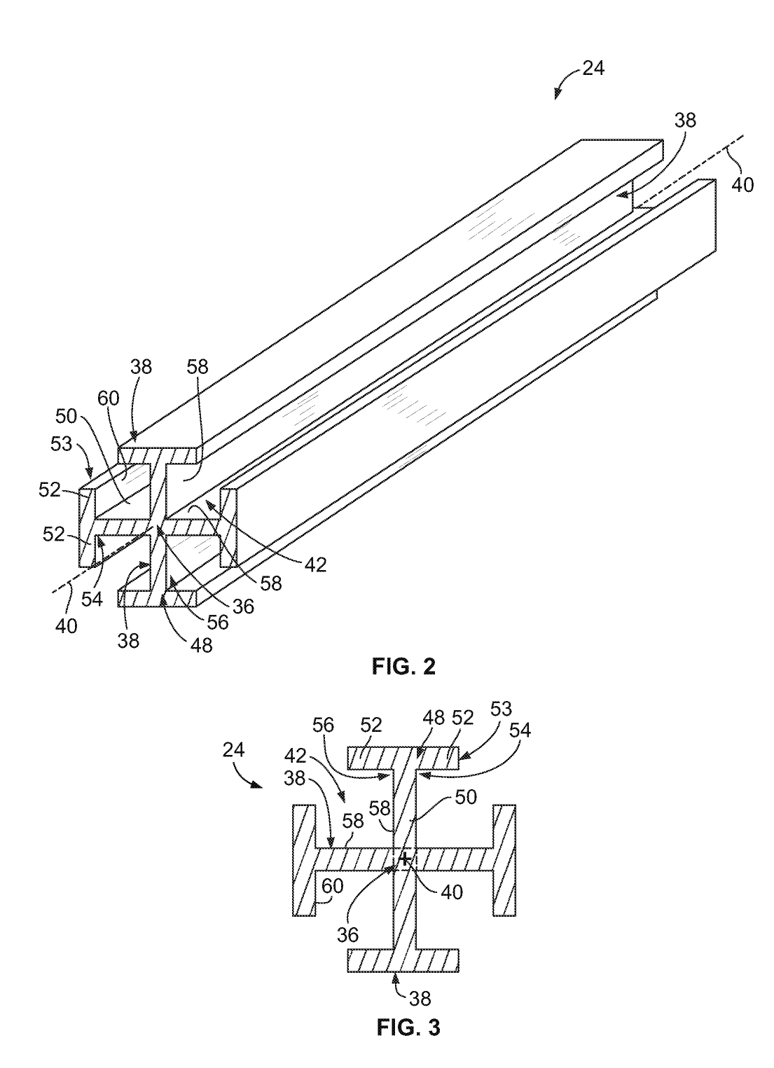

FIG. 2 is a perspective view of a portion of an exemplary embodiment of a central core 24. FIG. 3 is a cross-sectional view of the central core 24. The central core 24 includes a central hub 36 and a plurality of separators 38 that extend outwardly from the hub 36. Each of the separators 38 may be referred to herein as a “first”, a “second”, a “third”, and/or a “fourth” separator. The boundaries of the hub 36 are indicated in FIG. 3 with phantom lines for clarity. The hub 36 extends a length along a central longitudinal axis 40. The separators 38 extend radially outward from the hub 36 relative to the central longitudinal axis 40. Each adjacent pair of separators 38 defines a channel 42 therebetween. Each channel 42 is configured to receive a corresponding one of the twisted pairs 26 (FIGS. 1, 4, and 5) therein, as will be described below.

In the exemplary embodiment, the central core 24 includes four separators 38 that define four channels 42. and each channel 42 is positioned in a different quadrant of the central core 24. But, the central core 24 may include any number of the separators 38 that define any number of channels 42 for holding any number of twisted pairs 26. Moreover, the channels 42 may be arranged around the central longitudinal axis 40 in any other pattern than shown herein. The exemplary central core 24 shown herein includes a cross shape. Specifically, adjacent separators 38 of the exemplary central core 24 shown herein are angled at approximately 90° relative to each other. However, in addition or alternatively, the central core 24 may include other shapes, which may depend on the number of separators 38, the relative orientation and/or pattern of the separators 38, and/or the like.

The separators 38 extend outwardly from the hub 36. Each separator 38 includes an arm segment 50 and an end segment 48 that extends outwardly from the arm segment 50. The end segments 48 may each be referred to herein as a “first” and/or a “second” end segment. The end segment 48 of each separator 38 includes one or more finger segments 52. Each finger segment 52 may be referred to herein as a “first” and/or a “second” finger segment. The arm segments 50 extend outwardly from the hub 36. Each finger segment 52 extends outwardly from the corresponding arm segment 50 to a tip 53. Specifically, each arm segment 50 extends outwardly from the hub 36 to an end 56. The finger segments 52 extend from the arm segments 50 at bends 54 that are located at the ends 56 of the arm segments 50, such that the finger segments 52 extend outwardly from the end 56 of the corresponding arm segment 50. The finger segments 52 further define the channels 42 of the central core 24. Specifically, exterior surfaces 58 and 60 of the arm and finger segment 50 and 52, respectively, define boundaries of the channels 42. Each channel 42 is thus defined by the space extending between the exterior surfaces 58 and 60 of the corresponding separators 38.

In the exemplary embodiment, each separator 38 includes two finger segments 52 that extend outwardly from the corresponding arm segment 50 in opposite directions. Accordingly, each separator 38 includes a ‘T’ shape, as can be seen in both FIGS. 1 and 2. Alternatively, one or more of the separators 38 includes only one finger segment 52. Moreover, in some alternative embodiments one or more of the separators 38 includes more than two finger segments 52. In the exemplary embodiment, each finger segment 52 extends outwardly from the corresponding arm segment 50 at an angle of approximately 90°. Specifically, each of the bends 54 is approximately 90°. But, each finger segment 52 may extend from the corresponding arm segment 50 at a bend 54 having any other angle than approximately 90°, such as, but not limited to, an acute or obtuse angle.

The central core 24 is optionally fabricated from one or more dielectric materials to facilitate insulating the twisted pairs from each other, such as, but not limited to, PVC, polypropylene, foam polypropylene, a polymer, a fluoropolymer, a plastic, polyethylene, and/or the like. One example of a method of forming the central core 24 with one or more dielectric materials includes extruding or molding. Optionally, the central core 24 may include conductive materials in addition or alternatively to the dielectric materials to provide shielding between the twisted pairs 26. For example, the central core 24 may be fabricated entirely from one or more conductive materials or may include one or more conductive layers formed on one or more dielectric materials. One example of a conductive central core 24 includes forming the central core 24 using a laminated metal tape. In some embodiments, the central core 24 is relatively flexible, while in other embodiments the central core 24 is relatively rigid.

The central core 24 shown in FIGS. 2 and 3 is an exemplary core that can be used in accordance with one embodiment of the cable and/or sub-cables described and/or illustrated herein. In addition or alternatively, other known cores could be employed with the cable and/or sub-cables described and/or illustrated herein. The central core 24 illustrated herein is a product of Cable Components Group LLC of Framingham, Mass.

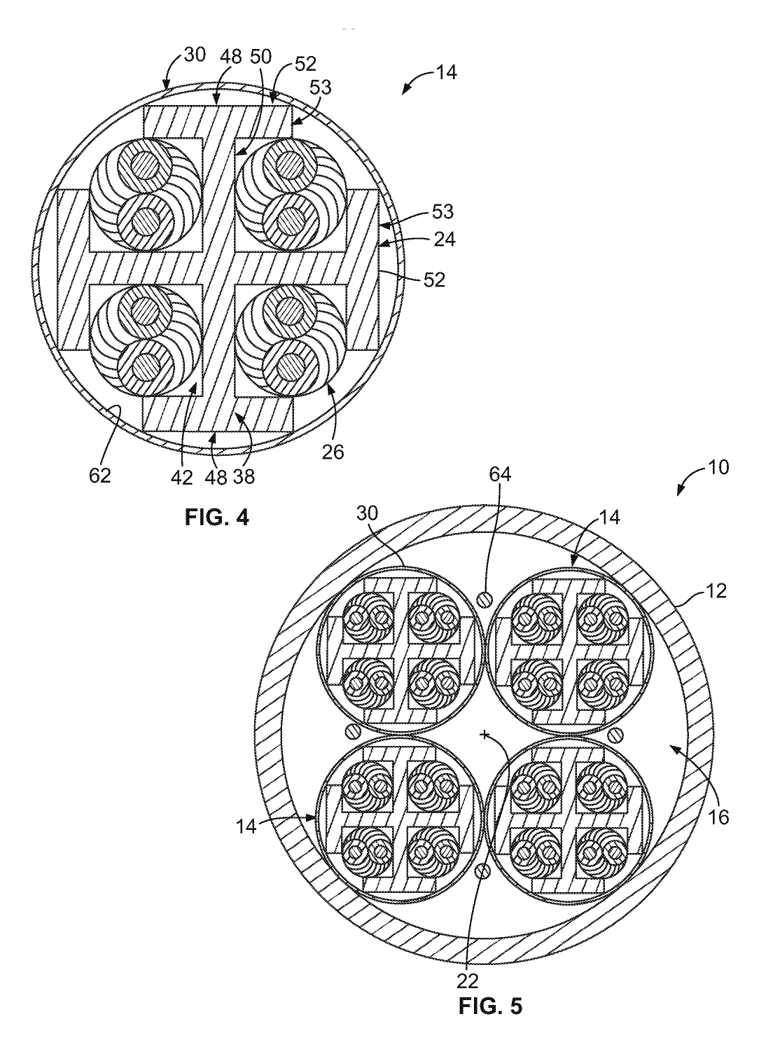

FIG. 4 is a cross sectional view of an exemplary embodiment of a sub-cable 14. In the exemplary embodiment, the sub-cable 14 includes the central core 24, four twisted pairs 26, and the shield 30. The shield 30 may be fabricated from any conductive materials, such as, but not limited to, a laminated metal tape, an aluminum polyimide laminated tape, an aluminum biaxially-oriented polyethylene terephthalate (BoPEt) laminated tape, a braid of conductive strands, fibers, and/or the like, a tube formed from a continuous (e.g., a sheet) conductive material, and/or the like. The shield 30 is optionally connected to a ground or other source of electrical energy to provide active shielding. The shield 30 extends around the central core 24 and the twisted pairs 26. Specifically, the shield 30 includes an internal passageway 62 within which the central core 24 and twisted pairs 26 extend. Each twisted pair 26 extends within a corresponding one of the channels 42 of the central core 24. Each separator 38 extends between two adjacent twisted pairs 26. Specifically, the arm segment 50 of each separator 38 extends between adjacent twisted pairs 26 to separate the adjacent twisted pairs 26 along at least a portion of the length of the sub-cable 14, and more specifically the cable 10 (FIGS. 1 and 5). As described above, the central core 24 may provide insulation and/or shielding between the twisted pairs 26. Although four are shown, each sub-cable 14 may include any number of twisted pairs 26.

The end segment 48 of each separator 38 extends between the shield 30 and one or more of the twisted pairs 26, and is optionally engaged with the shield 30 and/or the one or more twisted pairs 26. Specifically, in the exemplary embodiment, the tip 53 of each finger segment 52 extends between the shield 30 and a corresponding one of the twisted pairs 26. In the exemplary embodiment, each tip 53 is engaged with both the shield 30 and the corresponding twisted pair 26. Alternatively, one or more of the tips 53 does not engage the shield 30 and/or the corresponding twisted pair 26. Moreover, in some alternative embodiments, the central core 24 is configured to float within the passageway 62 of the shield 30 such that the tips 53 may move into and out of engagement with the shield 30. Still further, in some alternative embodiments one or more of the twisted pairs 26 is configured to float within the corresponding channel 42 such that the one or more twisted pairs 26 can move into and out of engagement with the corresponding tips 53. In addition or alternatively to the tips 53, other portions of the finger segments 52 may extend between and/or engage the shield 30 and/or the corresponding twisted pair 26.

As FIG. 4 illustrates, each twisted pair 26 is spaced apart from the shield 30. In other words, the twisted pairs 26 do not engage the shield 30. The finger segments 52 provide the spacing by extending between the twisted pairs 26 and the shield 30 as described above. The finger segments 52 also hold the twisted pairs 26 within the channels 42 and prevent the twisted pairs 26 from moving closer (than the corresponding channel 42) to the shield 30. Specifically, in the exemplary embodiment two finger segments 52 extend between each twisted pair 26 and the shield 30 to prevent the twisted pairs 26 from moving radially outward from the central longitudinal axis 40 into engagement with the shield 30. The spacing between the twisted pairs 26 and the shield 30 may facilitate reducing an amount of cross talk between twisted pairs within the sub-cable 14 and/or between the twisted pairs 26 of different sub-cables 14 within the cable 10.

The central core 24 and the twisted pairs 26 may be loaded into the passageway 62 of the shield 30 during a cabling operation. For example, the central core 24 and the twisted pairs 26 may be pulled into the passageway 62 during the cabling operation. Optionally, the central core 24 and the twisted pairs 26 are loaded into the passageway 62 simultaneously. Alternatively, the central core 24 is loaded into the passageway 62 either before or after the twisted pairs 26 are loaded into the passageway 62.

FIG. 5 is a cross-sectional view of the cable 10. The sub-cables 14 extend within the passageway 16 of the jacket 12 and are arranged radially about the central longitudinal axis 22 of the cable 10. In the exemplary embodiment, the sub-cables 14 are arranged in a pattern about the axis 22 such that the sub-cables 14 are arranged evenly about the axis 22 in different quadrants thereof. In the pattern shown in herein, the sub-cables 14 are each engaged with adjacent sub-cables 14 and with the jacket 12 to facilitate holding the sub-cables 14 in position and maintaining the pattern. Alternatively, one or more of the sub-cables 14 is configured to float within the passageway 16 of the jacket 12 such that the one or more sub-cables 14 may move into and out of engagement with other sub-cables 14 and/or the jacket 12. In alternative embodiments, the sub-cables 14 may be arranged in any other pattern about the axis 22 than is shown herein. Although four sub-cables 14 are shown, the cable 10 may include any number of sub-cables 14.

Optionally, the cable 10 includes one or more drain wires 64 positioned within the passageway 16 of the jacket 12. The drain wires 64 may provide a connection between the shields 30 of the sub-cables and a source of ground or other electrical energy. In the exemplary embodiment, the cable 10 includes four drain wires 64, but the cable 10 may include any number of drain wires 64.

The sub-cables 14 may be loaded into the passageway 16 of the jacket 12 during a cabling operation. For example, the sub-cables 14 may be pulled into the passageway 16 during the cabling operation. Optionally, the sub-cables 14 are loaded into the jacket 12 simultaneously with each other and/or the drain wires 64. In some embodiments, the sub-cables 14 are loaded into the jacket 12 either before or after the drain wires 64 are loaded into the jacket 12.

Referring again to FIG. 1, as described above, the jacket 12 and the insulative layers 32 at least partially surround the sub-cables 14 and the corresponding conductors 28, respectively. Accordingly, in some embodiments, the jacket 12 surrounds only a portion of the circumference of the group of sub-cables 14 and/or the insulative layers 32 surround only a portion of the circumference of the corresponding conductors 28. However, as shown in FIG. 1, the jacket 12 may surround an entirety of the circumference of the group of sub-cables 14. Similarly, the insulative layers 32 may surround an entirety of the circumference of the corresponding conductors 28, as also shown in FIG. 1. FIG. 1 also illustrates each shield 30 extending around an entirety of the circumference of the corresponding central core 24 and twisted pairs 26. However, each shield 30 may extend around only a portion of the circumference of the corresponding central core 24 and twisted pairs 26.

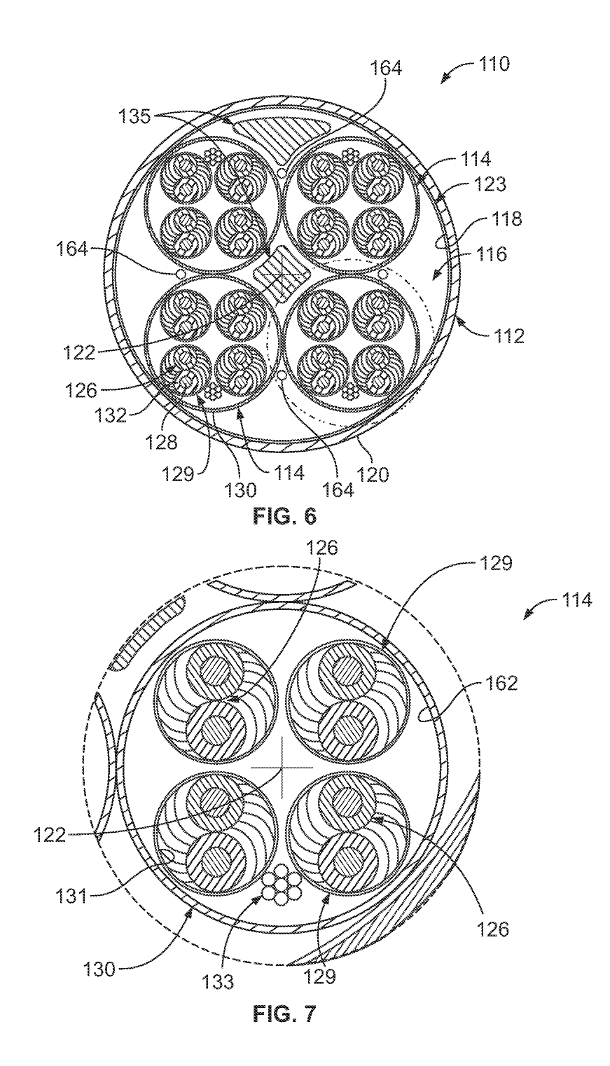

FIG. 6 is a cross-sectional view of another exemplary embodiment of a cable 110. In the description that follows, the cable 110 will be described and/or illustrated in terms of premise cabling, such as, but not limited to, a data communication cable and/or the like. However, it is to be understood that the benefits described and/or illustrated herein are also applicable to other types of cables, including, but not limited to, wires, cords, cables. and/or the like of any type. The following description and illustrations are therefore provided for illustrative purposes only and are but one potential application of the subject matter described and/or illustrated herein.

The cable 110 includes an insulative jacket 112 and a plurality of sub-cables 114 positioned within the jacket 112. The jacket 112 at least partially surrounds the sub-cables 114. Specifically, the jacket 112 includes an internal passageway 116 within which the sub-cables 114 extend. The sub-cables 114 extend within the passageway 116 along the length (only a portion of which is illustrated herein) of the cable 110. In some embodiments, the jacket 112 surrounds only a portion of the circumference of the group of sub-cables 114. However, as shown in FIG. 6, the jacket 112 may surround an entirety of the circumference of the group of sub-cables 114. The jacket 112 is fabricated from any insulative, non-conductive materials, such as, but not limited to, PVC, polypropylene, a polymer, a fluoropolymer, a plastic, polyethylene, and/or the like. In the exemplary embodiment, the jacket 112 includes an approximately smooth inner surface 118 and an approximately smooth outer surface 120. In alternative embodiments, the inner surface 118 and/or the outer surface 120 may not be approximately smooth. The cable 110 and the jacket 112 extend along a central longitudinal axis 122 that extends along the length of the cable 110. Each sub-cable 114 may be referred to herein as a “cable”.

The cable 110 optionally includes a conductive shield 123 that at least partially surrounds the sub-cables 114 and is at least partially surrounded by the jacket 112. In other words, the optional shield 123 extends radially (relative to the central longitudinal axis 122) between the jacket 112 and the sub-cables 114. In some embodiments, the optional shield 123 surrounds only a portion of the circumference of the group of sub-cables 114. However, as shown in FIG. 6, the optional shield 123 may surround an entirety of the circumference of the group of sub-cables 114. The optional shield 123 is at least partially electrically conductive. The optional shield 123 may be partially electrically insulative. For example, the optional shield 123 may be fabricated entirely from one or more conductive materials or may include one or more conductive layers formed on one or more dielectric materials. The optional shield 123 may be fabricated from any materials, such as, but not limited to, a laminated metal tape, an aluminum polyimide laminated tape, an aluminum biaxially-oriented polyethylene terephthalate (BoPEt) laminated tape, a braid of conductive strands, fibers, and/or the like, a tube formed from a continuous (e.g., a sheet) conductive material, and/or the like. In embodiments wherein the optional shield 123 includes one or more conducive layers formed on one or more dielectric materials (e.g., a laminated metal tape), the conductive layer(s) may be located on a radially inner side of the shield 123 (i.e., facing radially toward the sub-cables 114) or a radially outer side of the shield 123 (i.e., facing radially away from the sub-cables 114). Optionally, the conductive layer(s) engages one or more of the outer shields 130 (described below) and/or one or more of the drain wires 164 (described below) to electrically connect the optional shield 123 to the shield(s) 130 and/or the drain wire(s) 164. If the optional shield 123 is a tape, the tape may be wrapped around the sub-cables 114 in any manner, configuration, geometry, and/or the like, such as, but not limited to, a spiral (served) wrap, a cigarette wrap, and/or the like.

Optionally, and in addition or alternative to the optional shield 123, the cable 110 includes an electrically insulative tape (not shown) that at least partially surrounds the sub-cables 114 and is at least partially surrounded by the jacket 112. In some embodiments, the insulative tape surrounds only a portion of the circumference of the group of sub-cables 114. But, the insulative tape may surround an entirety of the circumference of the group of sub-cables 114. The insulative tape is fabricated from any insulative, non-conductive materials, such as, but not limited to, PVC, polypropylene, a polymer, a fluoropolymer, a plastic, polyethylene, and/or the like. The optional shield 123 may be referred to herein as a “second” outer shield and/or as a “tape”. The insulative tape described in this paragraph may be referred to herein as a “tape”.

Each of the sub-cables 114 includes a plurality of twisted pairs 126 of insulated conductors 128, a plurality of at least partially electrically conductive inner shields 129, and an at least partially electrically conductive outer shield 130. In the exemplary embodiment, each of the conductors 128 is at least partially surrounded by an insulative layer 132. In some embodiments, the insulative layers 132 surround only a portion of the circumference of the corresponding conductors 128. However, as shown in FIGS. 6 and 7, the insulative layers 132 may surround an entirety of the circumference of the corresponding conductors 128. The conductors 128 may be fabricated from any conductive materials, such as, but not limited to, copper and/or the like. The insulative layers 132 are fabricated from any insulative, non-conductive materials, such as, but not limited to, PVC, polypropylene, a polymer, a fluoropolymer, a plastic, polyethylene, and/or the like. The twisted pairs 126 may each be referred to herein as a “first”, a “second”, a “third”, and/or a “fourth” twisted pair. The inner shields 129 may each be referred to herein as a “first” and/or a “second” inner shield. Each of the outer shields 130 may be referred to herein as a “first” outer shield.

FIG. 7 is a cross sectional view or a portion of the cable 110 illustrating an exemplary embodiment of a sub-cable 114. In the exemplary embodiment, the sub-cable 114 includes four twisted pairs 126, lour inner shields 129, and the outer shield 130. Each of the inner shields 129 at least partially surrounds a corresponding twisted pair 126. Specifically, the inner shields 129 include channels 131 within which the corresponding twisted pairs 126 extend. In some embodiments, the inner shields 129 surround only a portion of the circumferences of the corresponding twisted pairs 126. But, and as shown in FIG. 7, each inner shield 129 may surround an entirety of the circumference of the corresponding twisted pair 126. The inner shields 129 are physically located on the corresponding twisted pair 126. In some embodiments, the inner shields 129 are engaged with the corresponding twisted pair 126. Optionally, and as can be seen in FIG. 7, the inner diameters of the inner shields 129 are substantially similar to the diameter of the periphery of the corresponding twisted pair 126. In the exemplary embodiment, only a single twisted pair 126 extends within the channel 131 of each inner shield 129. In other words, for each inner shield 129, no other twisted pair 126 besides the corresponding twisted pair 126 extends within the channel 131 in the exemplary embodiment. Accordingly, in the exemplary embodiment, each inner shield 129 does not surround any other twisted pair 126 besides the corresponding twisted pair 126. Although four are shown, each sub-cable 114 may include any number of twisted pairs 126 and any number of the inner shields 129.

Each inner shield 129 extends between the corresponding twisted pair 126 and the other twisted pairs 126 of the sub-cable 114 along at least a portion of the length of the cable 110 (FIG. 6). Each inner shield 129 electrically shields the corresponding twisted pair 126 from the other twisted pairs 126 of the sub-cable 114. The shielding of the twisted pairs 126 provided by the shields 129 may facilitate reducing an amount of cross talk between the twisted pairs 126 within the sub-cable 114 and/or between the twisted pairs 126 of different sub-cables 114 within the cable 110.

Each of the inner shields 129 may be partially electrically insulative. For example, each of the inner shields 129 may be fabricated entirely from one or more conductive materials or may include one or more conductive layers formed on one or more dielectric materials. The inner shields 129 may each be fabricated from any materials, such as, but not limited to, a laminated metal tape, an aluminum polyimide laminated tape, an aluminum biaxially-oriented polyethylene terephthalate (BoPEt) laminated tape, a braid of conductive strands, fibers, and/or the like, a tube formed from a continuous (e.g., a sheet) conductive material, and/or the like. In embodiments wherein an inner shield 129 includes one or more conducive layers formed on one or more dielectric materials (e.g., a laminated metal tape), the conductive layer(s) may be located on a radially inner side of the inner shield 129 (i.e., facing radially toward the corresponding twisted pair 126) or a radially outer side of the inner shield 129 (i.e., facing radially away from the corresponding twisted pair 126). Optionally, the conductive layer(s) engage one or more of the corresponding outer shield 130 and/or the corresponding drain wire 133 (described below) to electrically connect the inner shield 129 to the outer shield 130 and/or the drain wire 133. If an inner shield 129 is a tape, the tape may be wrapped around the corresponding twisted pair 126 in any manner, configuration, geometry, and/or the like, such as, but not limited to, a spiral (served) wrap, a cigarette wrap, and/or the like.

The outer shield 130 at least partially surrounds the twisted pairs 126 and the inner shields 129 of the sub-cable 114. The outer shield 130 includes an internal passageway 162 within which the twisted pairs 126 and the inner shields 129 extend. In some embodiments, the outer shield 130 surrounds only a portion of the circumference of the twisted pairs 126 and inner shields 129 of the sub-cable 114. However, as shown in FIGS. 6 and 7, each outer shield 130 may surround an entirety of the circumference of the corresponding group of twisted pairs 126 and inner shields 129. The outer shield 130 shields the twisted pairs 126 within the sub-cable 114 from the twisted pairs 126 (FIG. 6) of the other sub-cables 114 (FIG. 6) of the cable 110. The shielding provided by the outer shield 130 may facilitate reducing an amount of cross talk between the twisted pairs 126 of the sub-cable 114 and the twisted pairs 126 of different sub-cables 114 within the cable 110.

The outer shield 130 may be partially electrically insulative. For example, the outer shield 130 may be fabricated entirely from one or more conductive materials or may include one or more conductive layers formed on one or more dielectric materials. The outer shield 130 may be fabricated from any materials, such as, but not limited to, a laminated metal tape, an aluminum polyimide laminated tape, an aluminum biaxially-oriented polyethylene terephthalate (BoPEt) laminated tape, a braid of conductive strands, fibers, and/or the like, a tube formed from a continuous (e.g., a sheet) conductive material, and/or the like. In embodiments wherein the outer shield 130 includes one or more conducive layers formed on one or more dielectric materials (e.g., a laminated metal tape), the conductive layer(s) may be located on a radially inner side of the outer shield 130 (i.e., facing radially toward the twisted pairs 126) or a radially outer side of the outer shield 130 (i.e., facing radially away from the twisted pairs 126). Optionally, the conductive layer(s) engage one or more of the corresponding inner shields 129, the optional shield 123, one or more of the drain wires 164, and/or the corresponding drain wire 133 to electrically connect the outer shield 130 to the corresponding inner shield(s) 129, the drain wire(s) 164, the corresponding drain wire 133, and/or the optional shield 123. When the outer shield 130 is a tape, the tape may be wrapped around the twisted pairs 126 and the inner shields 129 in any manner, configuration, geometry, and/or the like, such as, but not limited to, a spiral (served) wrap, a cigarette wrap, and/or the like.

Optionally, one or more of the inner shields 129 and/or the outer shield 130 is electrically connected to a ground or other source of electrical energy to provide active shielding. For example, the sub-cable 114 optionally includes one or more drain wires 133 positioned within the passageway 162 of the outer shield 130 between the inner shields 129 and the outer shield 130. The drain wires 133 may provide a connection between the inner shields 129 and/or the outer shield 130 and a source of ground or other electrical energy. In the exemplary embodiment, the sub-cable 114 includes one drain wire 133, but the sub-cable 114 may include any number of drain wires 133.

In the exemplary embodiment, the drain wire 133 is spirally wrapped (served) around the twisted pairs 126 and the inner shields 129. However, the drain wire 133 may be wrapped in any manner, configuration, geometry, and/or the like, such as, but not limited to, a cigarette wrap and/or the like. Moreover, the drain wire 133 is not limited to being wrapped around the twisted pairs 126 and the inner shields 129. Rather, in some embodiments, the drain wire 133 extends along a path that is approximately parallel to the length of the sub-cable 114 (e.g., approximately parallel to the central longitudinal axis 122). The exemplary drain wire 133 is shown as including seven strands of material. However. the drain wire 133 may include any number of strands of material.

The inner shields 129 optionally engage the outer shield 130. In some embodiments, the inner shields 129 are configured to float within the internal passageway 162 of the outer shield 130 into and out of engagement with the outer shield 30. In other embodiments, the inner shields 129 are tightly packed within the outer shield 130 such that the inner shields 129 are engaged with the outer shield 130 along a majority, or an approximate entirety, of the length of the sub-cable 114. In still other embodiments, the inner shields 129 are spaced apart from the outer shield 130 along a majority, or an approximate entirety, of the length of the sub-cable 114.

The inner shields 129 are optionally electrically connected to the outer shield 130. For example, the inner shields 129 may be electrically connected to the outer shield 130 via engagement between the inner shields 129 and the outer shield 130, via the drain wire 133, and/or the like.

The twisted pairs 126 and the inner shields 129 may be loaded into the passageway 162 of the shield 130 during a cabling operation. For example, the twisted pairs 126 and the inner shields 129 may be pulled into the passageway 162 during the cabling operation. Optionally, the twisted pairs 126 and the inner shields 129 are loaded into the passageway 162 simultaneously. Alternatively, the inner shields 129 are loaded into the passageway 162 either before or after the twisted pairs 126 are loaded into the passageway 162.

Referring again to FIG. 6, the sub-cables 114 extend within the passageway 116 of the jacket 112 and are arranged radially about the central longitudinal axis 122 of the cable 110. In the exemplary embodiment, the sub-cables 114 are arranged in a pattern about the axis 122 such that the sub-cables 114 are arranged evenly about the axis 122 in different quadrants thereof. In the pattern shown herein, the sub-cables 114 are each engaged with adjacent sub-cables 114 and with the optional shield 123 (or the jacket 112 or the insulative tape) to facilitate holding the sub-cables 114 in position and maintaining the pattern. Alternatively, one or more of the sub-cables 114 is configured to float within the passageway 116 of the jacket 112 such that the one or more sub-cables 114 may move into and out of engagement with other sub-cables 114 and/or the optional shield 123 (or the insulative tape or the jacket 112). In alternative embodiments, the sub-cables 114 may be arranged in any other pattern about the axis 122 than is shown herein. Optionally, one or more filler elements 135 are positioned within the internal passageway 116 of the jacket 112, for example to facilitate holding the sub-cables 114 within the pattern, to facilitate providing the cable 110 with a predetermined shape (e.g., cylindrical), and/or the like. Although four sub-cables 114 are shown, the cable 110 may include any number of sub-cables 114.

Optionally, the cable 110 includes one or more drain wires 164 positioned within the passageway 116 of the jacket 112 between the sub-cables 114 and the jacket 112. The drain wires 164 may provide a connection between the outer shields 130 of the sub-cables 114 and a source of ground or other electrical energy. In the exemplary embodiment, the sub-cable 114 includes four drain wires 164, but the sub-cable 114 may include any number of drain wires 164. In the exemplary embodiment, the drain wires 164 extend along paths that are approximately parallel to the length of the cable 110 (e.g., approximately parallel to the central longitudinal axis 122). But, the drain wires 164 may be wrapped around the sub-cables 114, such as, but not limited to, a spiral (served) wrap, a cigarette wrap, and/or the like. The exemplary drain wires 164 are shown as including one strand of material. However, the drain wire 164 may include any number of strands of material.

Each of the filler elements 135 may be fabricated from one or more dielectric materials such that the tiller element 135 is at least partially insulative and non-conductive. In addition or alternative to the dielectric materials, each of the filler elements 135 may include conductive materials such that the filler element 135 is at least partially electrically conductive. For example, each of the filler elements 135 may be fabricated entirely from one or more conductive materials or may include one or more conductive layers formed on one or more dielectric materials. Optionally, when a filler element 135 is at least partially electrically conductive, the filler element 135 may engage and thereby electrically connect two or more of the outer shields 130 together. Moreover, and optionally, when a filler element 135 is at least partially electrically conductive the filler element 135 may serve as a drain wire, for example in addition or alternatively to one or more of the drain wires 164.

The sub-cables 114 may be loaded into the passageway 116 of the jacket 112 during a cabling operation. For example, the sub-cables 114 may be pulled into the passageway 116 during the cabling operation. Optionally, the sub-cables 114 are loaded into the jacket 112 simultaneously with each other and/or the drain wires 164. In some embodiments, the sub-cables 114 are loaded into the jacket 112 either before or after the drain wires 164 are loaded into the jacket 112.

The embodiments described and/or illustrated herein may provide a cable having an improved electrical performance as compared with at least some known cables. For example, the embodiments described and/or illustrated herein may provide a cable having a reduced amount of crosstalk and/or an increased amount of crosstalk isolation than at least some known cables. The embodiments described and/or illustrated herein may provide a cable having more than four twisted pairs of insulated conductors that complies with ISO/IEC 11801. The embodiments described and/or illustrated herein may provide a cable having more than four twisted pairs of insulated conductors that complies with ISO/IEC CAT7A. The embodiments described and/or illustrated herein may provide a cable that is configured to conduct electrical data signals at a rate of at least 1 Megahertz. The embodiments described and/or illustrated herein may provide a cable that is configured to conduct electrical data signals at a rate of at least 1 Gigahertz.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter described and/or illustrated herein without departing from its scope. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the above description and the drawings. The scope of the subject matter described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A cable comprising:
first and second twisted pairs of insulated conductors;
a first inner shield at least partially surrounding the first twisted pair, the first inner shield being at least partially conductive;
a second inner shield at least partially surrounding the second twisted pair, the second inner shield being at least partially conductive; and
an at least partially conductive outer shield at least partially surrounding the first and second twisted pairs and the first and second inner shields such that the first and second twisted pairs and the first and second inner shields extend within an internal passageway of the outer shield.

2. The cable of claim 1, wherein the first and second twisted pairs, the first and second inner shields, and the outer shield define a sub-cable of the cable, the cable comprising a plurality of the sub-cables.

3. The cable of claim 1, wherein the outer shield is a first outer shield, the cable further comprising a second outer shield at least partially surrounding the first outer shield, the second outer shield being conductive.

4. The cable of claim 1, wherein the first inner shield comprises a channel within which the first twisted pair extends, and wherein no other twisted pair extends within the channel.

5. The cable of claim 1, wherein the first and second inner shields do not surround any other twisted pairs besides the respective first and second twisted pairs.

6. The cable of claim 1, wherein the first and second inner shields are electrically connected to the outer shield.

7. The cable of claim 1, wherein at least one of the first inner shield is engaged with the first twisted pair or the second inner shield is engaged with the second twisted pair.

8. The cable of claim 1, wherein an inner diameter of at least one of the first inner shield and the second inner shield is substantially similar to a diameter of a periphery of the first and second twisted pairs, respectively.
further comprising an insulative jacket at least partially surrounding the first and second twisted pairs, the first and second inner shields, and the outer shield.

9. The cable of claim 1, wherein the cable is configured to conduct electrical data signals at a rate of at least 1 Megahertz.

10. A cable comprising:
an insulative jacket;
sub-cables positioned within the jacket such that the jacket at least partially surrounds the sub-cables, at least some of the sub-cables comprising:
first and second twisted pairs of insulated conductors;
a first inner shield at least partially surrounding the first twisted pair, the first inner shield being at least partially conductive;
a second inner shield at least partially surrounding the second twisted pair, the second inner shield being at least partially conductive; and
an at least partially conductive outer shield at least partially surrounding the first and second twisted pairs and the first and second inner shields such that the first and second twisted pairs and the first and second inner shields extend within an internal passageway of the outer shield.

11. The cable of claim 10, wherein the outer shield is a first outer shield, the cable further comprising a second outer shield at least partially surrounding the sub-cables, the second outer shield being conductive, the jacket at least partially surrounding the second outer shield.

12. The cable of claim 10, wherein the first inner shield comprises a channel within which the first twisted pair extends, and wherein no other twisted pair extends within the channel.

13. The cable of claim 10, wherein the first and second inner shields do not surround any other twisted pairs besides the respective first and second twisted pairs.

14. The cable of claim 10. wherein each sub-cable further comprises third and fourth twisted pairs of insulated conductors, the cable comprising four sub-cables.

15. The cable of claim 10, further comprising a filler element positioned within the jacket at least partially between adjacent sub-cables.

16. The cable of claim 10, wherein at least one of the sub-cables comprises a drain wire configured to electrically connect at least one of the first or second inner shields to the outer shield.

17. The cable of claim 10, wherein the first and second inner shields are electrically connected to the outer shield.

18. The cable of claim 10, further comprising a tape at least partially surrounding the sub-cables, the jacket at least partially surrounding the tape.

19. The cable of claim 10, wherein at least one of the first or second inner shields is engaged with the outer shield.

20. The cable of claim 10, wherein the cable is configured to conduct electrical data signals at a rate of at least 1 Megahertz.
